(19) United States
(12) Patent Application Publication
(10) Pub. No.: US 2026/0073892 A1
(43) Pub. Date: Mar. 12, 2026

(54) METHOD AND APPARATUS, DEVICE, MEDIUM AND PROGRAM PRODUCT FOR ADJUSTING WINDOW BRIGHTNESS

(71) Applicant: Beijing Zitiao Network Technology Co., Ltd., Beijing (CN)

(72) Inventors: Zeqing XIE, Beijing (CN); Yu LIU, Beijing (CN)

(21) Appl. No.: 19/326,600

(22) Filed: Sep. 11, 2025

(30) Foreign Application Priority Data
Sep. 12, 2024 (WO) PCT/CN2024/118563

(51) Int. Cl. G09G 5/10

(52) U.S. Cl. CPC G09G 5/10; G09G 2320/0686; G09G 2354/00; G09G 2360/144

(57) ABSTRACT

Embodiments of the present disclosure provide a method and apparatus for adjusting window brightness, a device, a medium and a program product. The method comprises detecting whether a change has occurred to system screen brightness of a device. The method also comprises obtaining a target brightness value for the system screen brightness in response to detecting that the system screen brightness has been changed. The method further comprises adjusting, based on the target brightness value, a window brightness of a target window of a target application running in the device.

### CROSS-REFERENCE TO RELATED APPLICATION(S)

This application claims priority to Chinese Application No. PCT/CN2024/118563 filed Sep. 12, 2024, the disclosure of which is incorporated herein by reference in its entirety.

### FIELD

Embodiments of the present disclosure generally relate to the field of device system control, and more specifically, to method and apparatus, device, medium and program product for adjusting window brightness.

### BACKGROUND

At present, the technology for adjusting system parameters of electronic devices (such as mobile phones) is increasingly favored by developers of various types of systems. Under normal conditions, in order to adjust system parameters, it is required to obtain write access of system. Besides, not all system parameters can be adjusted through obtaining the system write access. From the perspective of system security, some system parameters could not be adjusted by obtaining corresponding write access.

With development of technology related to electronic devices, for ease of use, the users may be allowed to manually adjust some related parameters of the windows in the applications on the electronic device without obtaining the system write access. Therefore, for different applications on the electronic device, the users may control the display of the windows by manually adjusting parameters of the windows. Further, the current adjustment for the parameters of the application windows may be further explored and investigated in many aspects.

### SUMMARY

Embodiments of the present disclosure provide a method and apparatus, a device, a medium and a program product for adjusting window brightness.

In accordance with a first aspect of the present disclosure, there is provided a method for adjusting brightness. The method comprises detecting whether a change has occurred to system screen brightness of a device. The method also comprises obtaining a target brightness value for the system screen brightness in response to detecting that the system screen brightness has been changed. The method further comprises adjusting, based on the target brightness value, a window brightness of a target window of a target application running in the device.

In accordance with a second aspect of the present disclosure, there is provided an apparatus for adjusting window brightness. The apparatus comprises a system screen brightness detecting module configured to detect whether a change has occurred to system screen brightness of a device; a target brightness value obtaining module configured to, in response to detecting that the system screen brightness has been changed, obtain a target brightness value for the system screen brightness; and a target window brightness adjusting module configured to adjust, based on the target brightness value, a window brightness of a target window of a target application running in the device.

In accordance with a third aspect of the present disclosure, there is provided an electronic device, comprising at least one processor; and a memory for storing at least one program, the at least one program, when executed by the at least one processor, causing the at least one processor to perform the method according to the first aspect of the present disclosure.

In accordance with a fourth aspect of the present disclosure, there is provided a computer-readable storage medium stored thereon with computer programs, the computer programs, when executed by a processor, causing the processor to perform the method according to the first aspect of the present disclosure.

In accordance with a fifth aspect of the present disclosure, there is provided a computer program product. The computer program product includes computer programs, which computer programs, when executed by a processor, causing the processor to perform the method according to the first aspect of the present disclosure.

It should be appreciated that the contents described in this Summary are not intended to identify key or essential features of the embodiments of the present disclosure, or limit the scope of the present disclosure. Other features of the present disclosure will be understood more easily through the following description.

### BRIEF DESCRIPTION OF THE DRAWINGS

Through the following detailed description of the example embodiments of the present disclosure with reference to the accompanying drawings, the above and other objectives, features, and advantages of the present disclosure will become more apparent. In the example embodiments of the present disclosure, the same reference sign usually indicates the same component.

FIG. 1 illustrates a schematic diagram of an example environment in which the device and/or method according to some embodiments of the present disclosure may be implemented;

FIG. 2 illustrates a schematic diagram of an example method for adjusting window brightness according to some embodiments of the present disclosure;

FIG. 3 illustrates a schematic diagram of an example for detecting system screen brightness according to some embodiments of the present disclosure;

FIG. 4 illustrates a schematic diagram of an example for adjusting window brightness of window according to some embodiments of the present disclosure;

FIG. 5 illustrates a schematic diagram of an example for adjusting window brightness according to some embodiments of the present disclosure;

FIG. 6 illustrates a schematic diagram of another example for adjusting window brightness of window according to some embodiments of the present disclosure;

FIG. 7 illustrates a schematic diagram of a further example for adjusting window brightness of window according to some embodiments of the present disclosure;

FIG. 8 illustrates a schematic diagram of one more example for adjusting window brightness of window according to some embodiments of the present disclosure;

FIG. 9 illustrates a schematic diagram of an example for adjusting window volume according to some embodiments of the present disclosure;

FIG. 10 illustrates a schematic diagram of an apparatus for adjusting window brightness according to some embodiments of the present disclosure;

FIG. 11 illustrates a schematic block diagram of an example device adapted to implement a plurality of embodiments of the present disclosure.

In each drawing, same or corresponding reference sign indicates the same or corresponding component.

### DETAILED DESCRIPTION OF EMBODIMENTS

It is to be understood that data involved in the technical solutions of the present disclosure, including but not limited to data per se, and acquisition or use of the data, should follow requirements of corresponding laws, regulations and rules.

It is to be appreciated that prior to the use of the technical solutions disclosed by various embodiments of the present disclosure, type, usage scope and application scenario of personal information involved in the present disclosure are made known to users through suitable ways in accordance with the relevant laws and regulations, to obtain user authorization.

For example, in response to receiving an active request from the users, a prompt message is sent to the users to clearly inform them that the operation requested to be executed needs to obtain and use their personal information. Accordingly, the users may voluntarily select, in accordance with the prompt message, whether to provide their personal information to software or hardware that performs operations of the technical solution, such as electronic device, application program, server or storage medium.

As an optional and non-restrictive implementation, in response to receiving an active request from the users, a prompt message is sent to the users, wherein the prompt message may be present in the form of pop-up window as an example and the prompt message may be displayed in text in the pop-up window. Besides, the pop-up window also may be provided with a select control through which the users may choose to “agree” or “disagree”the provision of personal information to the electronic device.

It should be appreciated that the above procedure for informing the users and obtaining the user authorization is only exemplary and does not restrict the implementations of the present disclosure. Other methods may also be applied to the implementations of the present disclosure as long as they comply with relevant regulations and laws.

Embodiments of the present disclosure will be described below in more details with reference to the drawings. Although the drawings illustrate some embodiments of the present disclosure, it should be appreciated that the present disclosure can be implemented in various manners and should not be limited to the embodiments explained herein. On the contrary, the embodiments are provided for a more thorough and complete understanding of the present disclosure. It is to be understood that the drawings and the embodiments of the present disclosure are provided merely for the exemplary purpose, rather than restricting the protection scope of the present disclosure.

In the description of the embodiments of the present disclosure, the term “includes” and its variants are to be read as open-ended terms that mean “includes, but is not limited to.” The term “based on” is to be read as “based at least in part on.” The term “one embodiment” or “this embodiment” is to be read as “at least one example embodiment.” The terms “first”, “second” and so on can refer to same or different objects. The following text also may include other explicit and implicit definitions.

There are still many problems to be addressed during adjustment of window brightness. For example, while using an application A on their mobile phones, the users may intend to adjust the brightness of the application A. In general, there are two ways for such adjustment. One is that the users may adjust the brightness of the system screen, i.e., the brightness of the mobile phone as a whole is adjusted. The other is that the users may adjust the brightness of the application. For example, the users may only adjust the brightness of the application A while the brightness of the entire system and other applications remains the same.

In the above traditional solution, under a mode where the system screen brightness is adjusted, when users intend to adjust the system screen brightness, it is required to invoke a system-level write access to the mobile phone. An adjustable range of the brightness may be subsequently obtained. The brightness range for example may be from 0 to 255 or from 0 to 1023 depending on implementation techniques of equipment supplier. The brightness is then adjusted. In such case, for example, after the system screen brightness is adjusted to 200 in the application A, the brightness of the entire system is maintained at 200. In a mode where the brightness of the application is adjusted, when the users adjust the brightness of the application A, there is no need to invoke the system write access of the mobile phone. Under the circumstances, when the users adjust the brightness to 0.8 in the application A (window brightness of 0-1 corresponding to system brightness 0-255), only the application A keeps using the adjusted value. When the users switch from the application A to the system desktop of the mobile phone, the brightness of the screen is still the original system screen brightness.

Accordingly, when the system screen brightness of the electronic device is adjusted, the brightness of the application window could not be adjusted adaptively; besides, in case of adjusting the window brightness, automatic adjustment could not be adaptively made in accordance with the system screen brightness, which further affects user experience.

To at least solve the above and other potential problems, embodiments of the present disclosure provide a method for adjusting window brightness. In this method, a computing device may first detect whether a change has occurred to the system screen brightness of the device. For example, the change of the system screen brightness may be determined by the computing device through detecting a resource identifier corresponding to the system screen. Then, after detecting that the system screen brightness has been changed, the computing device obtains a target brightness value for the system screen brightness, and the target brightness value is a current brightness value after the change of the system screen brightness. In the end, the computing device adjusts a window brightness of a target window of a target application running in the device after obtaining the target brightness. According to this method, the brightness of the window of the application running in the device is correspondingly adjusted according to the change of the system screen brightness of the device, so as to adaptively adjust the brightness of the window in the application without the system write access and further enhance the user experience.

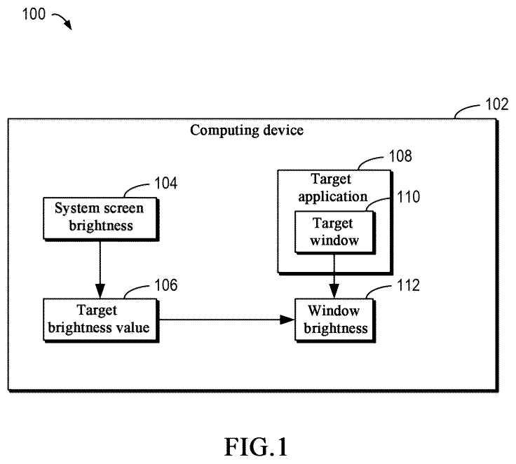

Embodiments of the present disclosure are to be described in details below with reference to the drawings, wherein FIG. 1 illustrates an example environment in which the device and/or method of the embodiments of the present disclosure may be implemented. In the environment 100, the computing device 102 first detects whether a change has occurred to the system screen brightness 104. Then, the computing device 102 may obtain the current brightness value of the system screen brightness 104 after detecting that the brightness of the system screen has been changed. To facilitate description, the current brightness value may be referred to as target brightness value 106. In the end, subsequent to obtaining the target brightness value 106, the computing device 102 further adjusts a window brightness 112 of a target window 110 of a target application 108 running in the device based on the target brightness value 106.

Examples of the computing device 102 include, but not limited to, personal computer, server computer, handheld or laptop device, mobile device (such as mobile phone, Personal Digital Assistant (PDA), media player and the like), multi-processor system, consumer electronics, minicomputer, main frame computer and a distributed computing environment including any of the above systems or devices etc.

As shown in FIG. 1, the computing device 102 may first detect whether a change has occurred to the system screen brightness 104 of the device, wherein the change of the system screen brightness is determined by the resource identifier corresponding to the system screen. For example, it is determined whether the system screen brightness has changed by detecting the resource identifier corresponding to the setting of the system screen brightness.

In some embodiments, different resource identifiers in the computing device may reflect information of changes of various device states, such as information of screen brightness change of the device, information of volume change of the device and information regarding ON or OFF of the screen of the device etc.

After detecting the change of the system screen brightness 104, the computing device 102 may obtain a target brightness value 106 of the system screen brightness 104. In some embodiments, after detecting the change of the system screen brightness 104, the computing device 102 accesses the system information of the device, i.e., reading the system information to obtain the information related to the system screen brightness in the system information. When accessing the system information, the computing device obtains the information only by reading without requiring the write access of the system to modify corresponding system information.

In some embodiments, there is a mapping relation between the range of the system screen brightness of the screen of the device and the range of the window brightness. It is usually required to map the brightness value of the system brightness to the range of the window brightness. For example, the range of the system screen brightness is from 0 to 255 and the range of the window brightness is a floating number between 0 and 1. The computing device may convert the brightness value within the range of 0 to 255 into a value of a floating point number between 0 and 1. The original brightness value 0 corresponds to the converted floating point number 0, and the original brightness value 255 corresponds to the converted floating point number 1.

In some embodiments, the maximum brightness value of the system screen of the device may be 1023, 2047 or 4095 etc., and may differ depending on technology implementations of various devices.

Maximum value and minimum value of the system screen brightness of the above device may be set when the device leaves the factory. In addition, the maximum value and the minimum value of the brightness may also be set by the users on their own initiative in the system setting of the device.

In the end, after obtaining the target brightness value 106, the computing device 102 further adjusts a window brightness 112 of a target window 110 of a target application 108 running in the device based on the target brightness value 106. In some embodiments, multiple target applications may be running on the device and each of the multiple target applications may also have a plurality of windows respectively.

In some embodiments, the window brightness of the target window of a plurality of target applications may be adaptively adjusted in accordance with the change of the system screen brightness. Additionally, the window brightness may be adjusted according to an adjustment policy. In one example, the adjustment policy may be pre-configured. For example, the adjustment policy may be pre-determined based on the setting of each target application. In another example, the adjustment policy may be determined based on the policy voluntarily selected by the users, to further implement adaptive adjustment of the target window.

According to this method, the brightness of the window of the application running in the device is correspondingly adjusted according to the change of the system screen brightness of the device, so as to adaptively adjust the brightness of the window in the application without the system write access and further enhance the user experience.

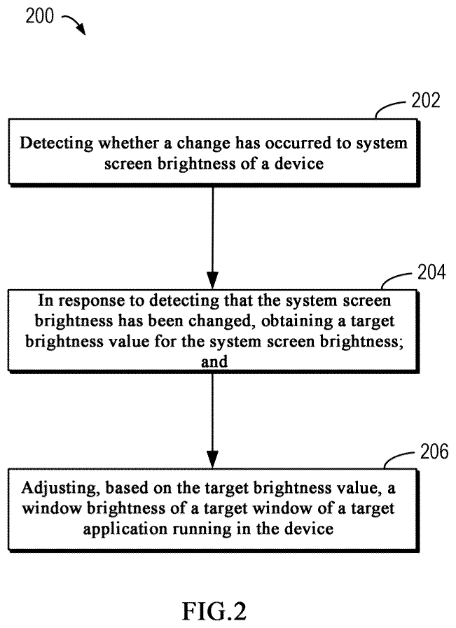

The schematic diagram of an example environment in which the device and/or method according to some embodiments of the present disclosure may be implemented has been described above with reference to FIG. 1. Next, a schematic diagram of an example method for adjusting window brightness according to some embodiments of the present disclosure is to be depicted below with reference to FIG. 2. The method in FIG. 2 may be executed by the computing device 102 in FIG. 1 and/or any suitable computing devices.

As shown in FIG. 2, in the example method 200, the computing device 102 detects whether a change has occurred to the system screen brightness 104 of the device at block 202. In order to fulfill adaptive adjustment of the brightness of the window of the application running on the computing device 102, it is required to monitor the system screen brightness.

In some embodiments, the resource identifier in the computing device 102 may reflect the information related to changes of the states of the computing device. For example, different resource identifiers may be provided to reflect information of the changes of the system screen brightness of the device, information of the changes of the volume of the device and information regarding ON or OFF of the screen of the device etc. Accordingly, the change of the system screen brightness may be determined by detecting the resource identifier corresponding to the brightness change of the screen. For example, the change of the system screen brightness may be determined by detecting the resource identifier Settings.System.SCREEN_BRIGHTNESS from the screen system.

Furthermore, in order to detect whether a change has occurred to the system screen brightness, it is required to match the obtained resource identifier with the pre-stored resource identifier related to the change of the system screen brightness, to detect whether the obtained identifier is a resource identifier related to the change of the system screen brightness. In case of a match between two resource identifiers, it is determined that the system screen brightness has been changed. If the information of the two resource identifiers does not match, it is determined that the system screen brightness is not changed.

In some embodiments, the computing device may determine whether a change has occurred to the system screen brightness by detecting any suitable information related to the system screen brightness.

At block 204, in response to detecting that the system screen brightness 104 is changed, the computing device 102 obtains the target brightness value 106 for the system screen brightness 104. After it is determined that the system screen brightness 104 has been changed, it is further required to obtain the current system screen brightness to adjust the brightness of the application window.

In some embodiments, after detecting the change of the system screen brightness 104, the computing device 102 will obtain the information related to the system screen brightness in the system information by accessing the system information of the device. The computing device, when accessing the system information, may obtain the current brightness value.

For example, a function for obtaining brightness value is set at a system software code level of the device. The computing device may obtain the target brightness value 106 of the system screen brightness through the function for obtaining brightness value without requiring system write access.

In some embodiments, the system screen brightness may be adjusted by the users on their own initiative in a system control center of the device. For example, the users adjust the system screen brightness from 120 to 180 in the system control center.

In some embodiments, the system screen brightness is automatically adjusted in accordance with a light intensity received by a photosensitive sensor of the system screen of the device. For example, when the photosensitive sensor integrated on the screen receives strong external light irradiation, the system screen brightness automatically increases; or when the photosensitive sensor receives weak external light irradiation, the system screen brightness automatically decreases. Additionally, a control switch for automatically adjusting the system screen brightness according to the photosensitive sensor may be turned on or off by the users on their own initiative in the system control center of the device.

In the end, at block 206, the computing device 102 adjusts the window brightness 112 of the target window 110 of the target application 108 running in the device based on the target brightness value 106. After obtaining the system screen brightness, the computing device may further adjust the window brightness with the system screen brightness.

In some embodiments, the window brightness of the target window of a plurality of target applications may be adaptively adjusted according to the changes of the system screen brightness. The adaptive adjustment policy may differ from one application to another. For example, the policy may be increasing the brightness of the window for the application A and the policy may be decreasing the brightness of the window for the application B. In addition, the policy of the adaptive adjustment also may be targeted at the window in the application. Therefore, different windows in one application may have various brightness adjustment methods. For example, with respect to a first window in the application A, the window brightness may be correspondingly reduced when the system screen brightness increases; with respect to a second window in the application A, the window brightness may vary with the change of the system screen brightness.

In some embodiments, the window brightness of the target windows of a plurality of target applications is the system screen brightness, and when the system screen brightness changes, the window brightness of a plurality of target windows does not change and remains at the original window brightness.

In some embodiments, a content parser for the running target application is included in the software level of the device. The content parser is a part of underlying codes of the system of the device and mainly receives a notification for the change of the system screen brightness. Besides, the computing device also registers a content observer in the content parser. The task of the content observer is to monitor whether the content parser receives a notification for the change of the system screen brightness and receive the notification for the change of the system screen brightness sent from the content parser. After receiving from the content parser the notification for the change of the system screen brightness, the content observer will further control a brightness adjustment module in the target application to adjust the window brightness of the target window in the target application.

In some embodiments, the target application may include a plurality of target windows. When the target application switches the first target window to the second target window, the computing device may maintain the window brightness value of the second target window consistent with the window brightness value of the first target window.

In some embodiments, in case that the target application switches the first target window to the second target window, the computing device logs out the content observer which is originally registered in the content parser and corresponds to the first target window and simultaneously registers a content observer corresponding to the second target window in the content parser. Therefore, the change of the system screen brightness may be applied to the adjustment of the window brightness of the second target window.

In some embodiments, the system screen brightness and the window brightness have the same value range. To adjust the target window brightness, the brightness of the window may be adjusted directly in accordance with the detected target brightness value of the system screen brightness. In some embodiments, the system screen brightness and the window brightness have different value ranges. When the brightness of the target window is adjusted, it is required to first adjust the obtained target brightness value of the system screen brightness to be within a predetermined range of the window brightness. For example, the target brightness value is adjusted to be within the window brightness range of 0-1. Afterwards, the computing device adjusts the brightness of the window according to the adjusted target brightness value. To facilitate the description, the changes of the system screen brightness and the window brightness are to be described within the same numerical range below.

When the window brightness is adjusted according to the target brightness value, the adjustment may be performed according to different adjustment policies. In some embodiments, the target policy for adjusting the window brightness of the target window may be increasing the brightness of the window when the target brightness value is lower than a first predetermined threshold. For example, in case that the target brightness value is lower than 0.2, the window brightness of the target window increases, such as to 0.6. The target policy also may include decreasing the window brightness of the target window (e.g., to 0.7) when the target brightness value is greater than a second predetermined threshold (e.g., above 0.8). Alternatively, the adjustment policy also may include increasing the window brightness by a predetermined amount or margin relative to the system screen brightness.

In some embodiments, the adjustment policy for the window brightness value may be pre-set. The adjustment policy may also be set or selected by the users. For example, a set of policies may be pre-set and the users may then select one from the set of policies.

In some embodiments, a plurality of target policies in the set of policies is executed separately. Alternatively, a plurality of target policies in the set of policies may be used and executed in combination by the computing device.

In some embodiments, the performance mode of the device, such as high performance mode, low performance mode and balanced mode etc., may be selected in the system control center of the device. In one example, when the device is in the high performance mode, the window brightness of the window may be set to be higher than the target brightness of the system screen. In another example, when the device is in the low performance mode, the window brightness of the window may lower than the target brightness of the system screen. In a further example, when the device is in the balanced mode, the window brightness of the window may be kept consistent with the target brightness of the system screen. Besides, the system screen brightness also may be adjusted to different target brightness depending on the performance mode.

In some embodiments, the performance mode of the device is selected by the users in the system control center. In some other embodiments, the performance mode of the device may automatically change in accordance with the power of the system battery. For example, when the battery power is above 80%, the device is in the high performance mode; when the battery power is between 50% and 80%, the device is in the balanced mode; when the battery power is lower than 50%, the device is in the low performance mode.

In some embodiments, the system screen brightness may be dynamically adjusted. The computing device will obtain the time information in the system information and adjust the target brightness value of the system screen brightness according to the obtained time information. For example, the following description is provided in the scenario where the system screen brightness is mapped to between 0 and 1. When the computing device determines the system time to be 9 o'clock in the morning, the target brightness value is adjusted to be between 0.6 and 1. In such case, the target brightness value of the system screen brightness has a minimum value of 0.6 and a maximum value of 1. If the computing device determines the system time to be 11 o'clock at night, the predetermined range of the target brightness value is adjusted to be between 0 and 0.5. Accordingly, the target brightness value of the system screen brightness has a minimum value of 0 and a maximum value of 0.5.

In some embodiments, in addition to detecting the system screen brightness and automatically making adaptive adjustments on the system screen brightness according to a set of policies, the computing device also may detect the system volume and automatically make adaptive adjustments on the system volume based on the set of policies.

According to this method, the brightness of the window of the application running in the device is correspondingly adjusted according to the change of the system screen brightness of the device, so as to adaptively adjust the brightness of the window in the application without the system write access and further enhance the user experience.

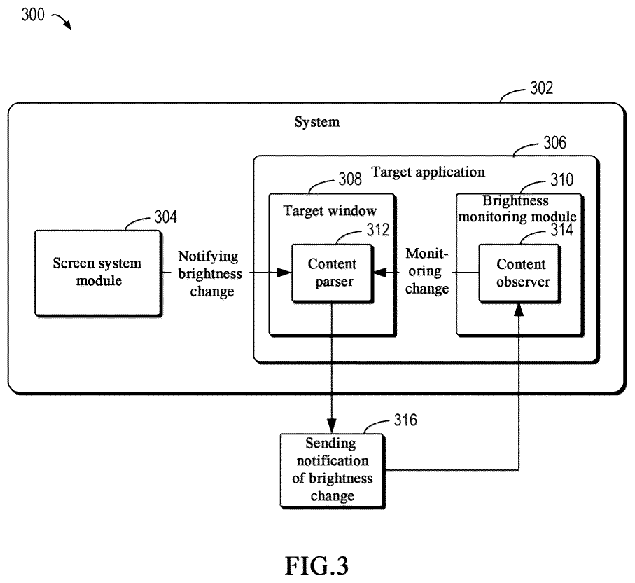

The schematic diagram of an example method for adjusting window brightness in accordance with some embodiments of the present disclosure has been described above with reference to FIG. 2. Next, a schematic diagram of an example for detecting the system screen brightness in accordance with some embodiments of the present disclosure is to be depicted in conjunction with FIG. 3. The example of FIG. 3 may be applied into the computing device 102 in FIG. 1 or any suitable computing devices.

In the example 300 shown by FIG. 3, a system 302 corresponding to the computing device 102 includes a screen system module 304 and a running target application 306.

In some embodiments, resource identifier information corresponding to state changes of the device may be generated in the screen system module, and the resource identifier information is used for indicating state change of the device, such as change of the screen brightness of the device or ON or OFF of the screen of the device.

Additionally, the target application 306 also includes a target window 308, and the target window 308 is a first target window. A content parser 312 for the running first target window is included in the software level of the device. The content parser 312 is part of the underlying codes of the system of the device. The content parser 312 is mainly used for receiving notification messages of the changes of the system screen brightness from the screen system module 304.

Upon receiving a notification message from the screen system module 304 notifying the changes of the system screen brightness, the content parser 312 sends a notification 316 of brightness change to a content observer 314 in a brightness monitoring module 310.

The content observer 314 is registered by the content parser 312 at the software level, to monitor whether the content parser 312 receives a notification about the changes of the system screen brightness and receive the notification about the changes of the system screen brightness from the content parser 312.

The content observer 314 may receive the resource identifier. In some embodiments, in addition to receiving the resource identifier indicating the change of the system screen brightness from the content parser, the content observer 314 also receives other resource identifiers. To detect whether a change has occurred to the system screen brightness, it is required to match the received resource identifier with the pre-stored reference resource identifier corresponding to the system screen brightness. If the two identifiers match, it indicates that a change has occurred to the system screen brightness; otherwise, it indicates that the system screen brightness does not change.

In some embodiments, when the first target window is switched to other target windows in the target application, the content parser will first log out the content observer previously registered in the first target window, then re-register a content observer in a second target window, and further re-detect the changes of the system screen brightness with respect to the second target window.

Through this method, the content observer is registered in the target window with the content parser at the software level, so as to obtain the changes of the system screen brightness without the system write access and further enhance the user experience.

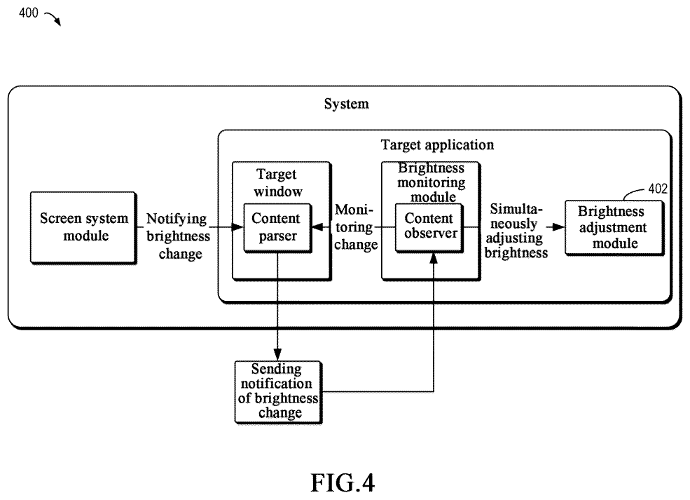

The schematic diagram of an example for detecting system screen brightness according to some embodiments of the present disclosure has been described above with reference to FIG. 3. Next, a schematic diagram of an example for adjusting the window brightness of the target window according to some embodiments of the present disclosure is to be depicted with reference to FIG. 4.

In the example 400, based on the previous example 300, when a change of the system screen brightness of the device is detected, a brightness adjustment module 402 in the target application will adjust the window brightness of the first target window in accordance with the target policy in the set of policies.

In some embodiments, in one target policy, when the target brightness is lower than a first predetermined threshold, e.g., 0.7, the window brightness of the target window increases for example to 0.7; when the target brightness value is lower than a second predetermined threshold, such as 0.8, the window brightness of the target window decreases for example to 0.7.

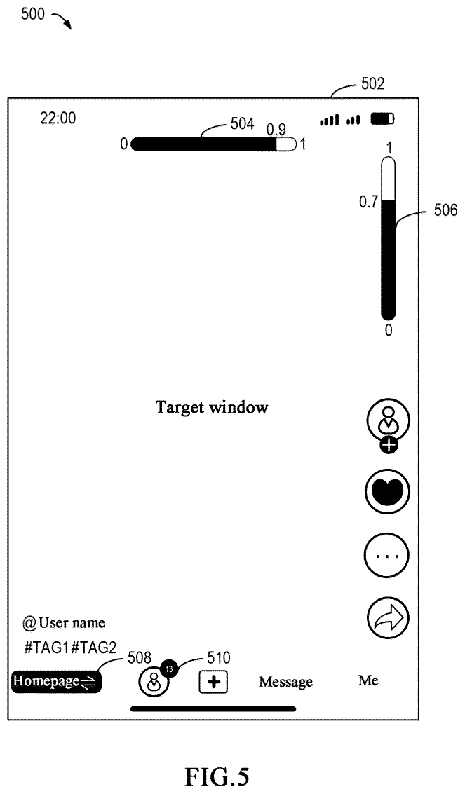

The schematic diagram of an example for adjusting the window brightness of the target window according to some embodiments of the present disclosure has been described above with reference to FIG. 4. Next, a schematic diagram of an example for adjusting the window brightness according to some embodiments of the present disclosure is to be depicted with reference to FIG. 5.

In the example 500, the target application is running in a system screen 502 and a window of the target application is also being displayed in the screen. The window corresponds to a homepage tag 508 in the target application, which is also referred to as a first target window; a window for a tag 510 is known as a second target window.

To facilitate description, a target brightness value 504 for the system screen is displayed at the top of system screen and a window brightness value 506 for the window brightness of the target window is displayed at an upper right part of the system screen.

In some embodiments, the window brightness value 506 is invisible and the target brightness value 504 may be adjusted by a left-slide or right-slide operation on it.

In some embodiments, the target brightness value of the system may be adjusted by the users in the system control center of the device.

In the example 500, the target policy in the set of policies is to reduce the window brightness value of the target window when the target brightness value is greater than the first threshold value. For example, when the target brightness value is adjusted to 0.9, which is greater than the predetermined threshold of 0.7, the brightness value of the target window is reduced to 0.7.

In some embodiments, when the computing device detects that the current system time is 10 o'clock at night, the window brightness is reduced from 0.9 to 0.7. In some embodiments, when the computing device detects that the current device is in the low performance mode, the window brightness is reduced from 0.9 to 0.7.

In some embodiments, when the computing device switches the first target window to the second target window, the content parser in the target application will first log out the content observer previously registered in the first target window, re-register a content observer for the second target window and re-detect the changes of the system screen brightness in the second target window.

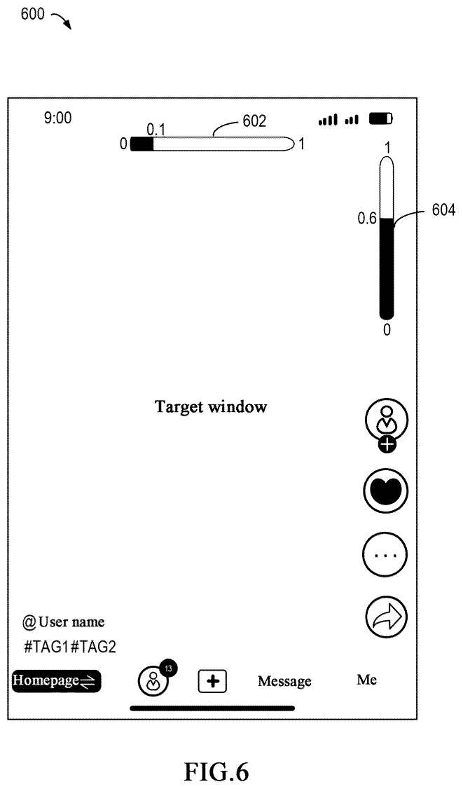

The schematic diagram of an example for adjusting the window brightness according to some embodiments of the present disclosure has been described above with reference to FIG. 5. Next, a schematic diagram of another example for adjusting the window brightness according to some embodiments of the present disclosure is to be depicted with reference to FIG. 6.

In the example 600, the target policy in the set of policies is to increase the window brightness value 604 of the target window when the target brightness value 602 is smaller than the second predetermined threshold. For example, when the target brightness value is adjusted to 0.1, which is smaller than the predetermined threshold of 0.5, the brightness value of the target window increases to 0.6.

In some embodiments, when the computing device detects the current system time to be 9 o'clock in the morning, the window brightness is increased from 0.1 to 0.6. In some embodiments, when the computing device detects that the current device is in high performance mode, the window brightness is increased from 0.1 to 0.6.

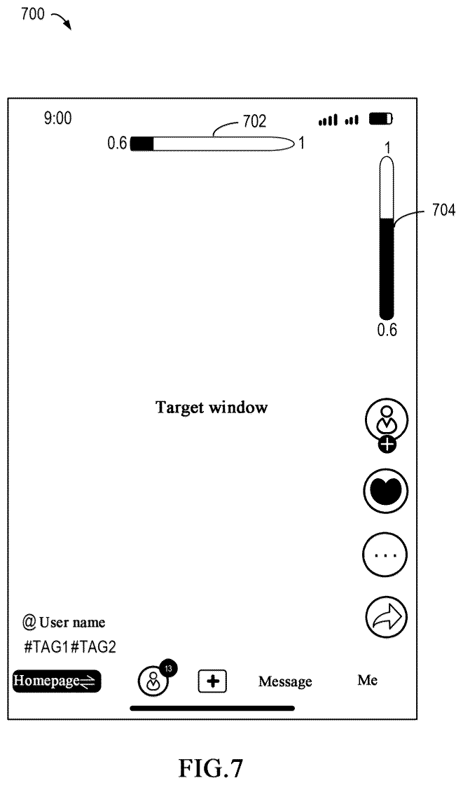

The schematic diagram of another example for adjusting the window brightness according to some embodiments of the present disclosure has been described above with reference to FIG. 6. Next, a schematic diagram of a further example for adjusting the window brightness according to some embodiments of the present disclosure is to be depicted with reference to FIG. 7.

In the example 700, the target policy in the set of policies is to limit the range of the target brightness value 702 and adaptively adjust the window brightness value 704.

In some embodiments, the range of the target brightness value may be limited between 0.6 and 1, i.e., the range for the adjustment of the target brightness value is from 0.6 to 1. It is to be understood that the above example is provided merely for describing the present disclosure, rather than restricting it.

In some embodiments, when the computing device detects that the current device is in high performance mode, the range of the target brightness value may be limited between 0.6 and 1, i.e., the range for the adjustment of the target brightness value is from 0.6 to 1.

In some embodiments, after the computing device limits the target brightness value in a range of 0.6 to 1, the window brightness is increased according to the selected target policy (which for example indicates that the target brightness value is lower than 0.7). Therefore, when the target brightness value is adjusted to 0.6, which is lower than the predetermined threshold of 0.7, the brightness value of the target window may be increased to 0.8.

In some embodiments, when the computing device detects the current system time to be 9 o'clock in the morning, the window brightness is increased from 0.6 to 0.8. In some embodiments, when the computing device detects that the current device is in high performance mode, the window brightness is increased from 0.6 to 0.8.

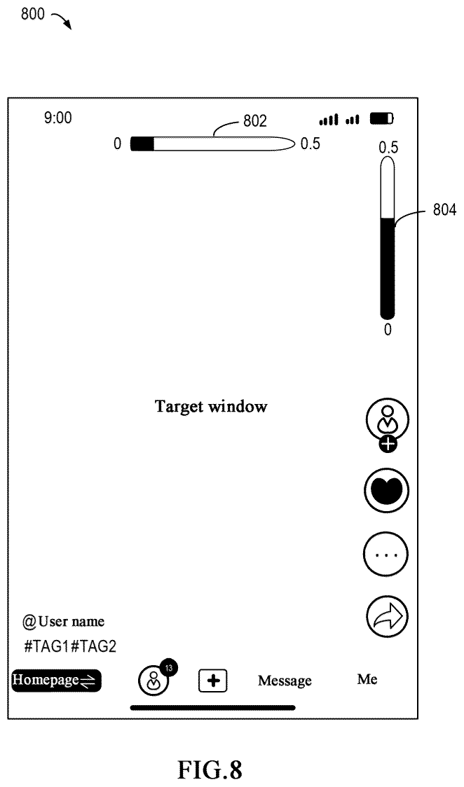

The schematic diagram of a further example for adjusting the window brightness according to some embodiments of the present disclosure has been described above with reference to FIG. 7. Next, a schematic diagram of one more example for adjusting the window brightness according to some embodiments of the present disclosure is to be depicted with reference to FIG. 8.

In the example 800, the target policy is to limit the range of the target brightness value 802 and adaptively adjust the window brightness value 804. When the computing device limits the range of the target brightness value between 0 and 0.5, the range for the target brightness value adjustment is as low as 0 and as high as 0.5. It is to be understood that the above example is provided merely for describing the present disclosure, rather than restricting it.

In some embodiments, when the computing device detects that the current device is in low performance mode, the range of the target brightness value is limited between 0 and 0.5 and the range for the adjustment of the target brightness value is a minimum of 0 and a maximum of 0.5.

In some embodiments, after the computing device limits the target brightness value in a range of 0 to 0.5, it is detected that a target policy is selected from the set of policies. For example, the policy indicates increasing the window brightness when the target brightness value is smaller than 0.3. In such case, the brightness value of the target window may be increased to 0.4.

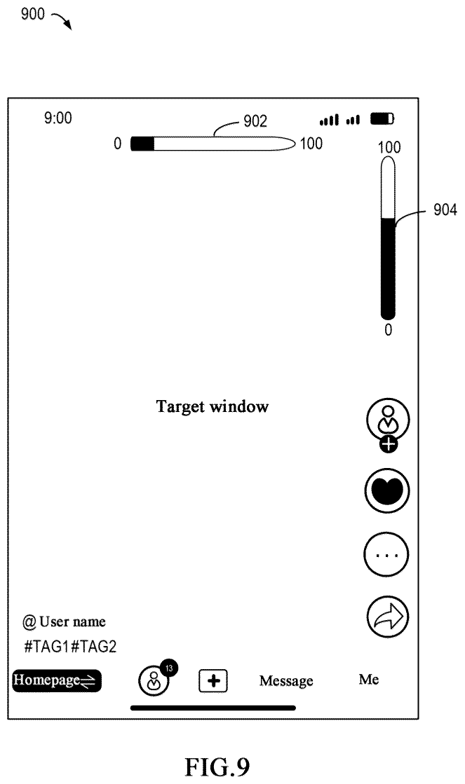

The schematic diagram of one more example for adjusting the window brightness according to some embodiments of the present disclosure has been described above with reference to FIG. 8. Next, a schematic diagram of an example for adjusting window volume according to some embodiments of the present disclosure is to be depicted with reference to FIG. 9.

In the example 900, the target volume value 902 for the system screen is displayed at the top of the system screen and the window volume value 904 for the target window is displayed at an upper right part of the system screen.

In some embodiments, the window volume value 904 is invisible and the target volume value 902 may be adjusted by a left-slide or right-slide operation on it.

In some embodiments, the target volume value of the system may be adjusted by the users in the system control center of the device.

In some embodiments, the target policy for adjusting the window volume is to lower the window volume value of the target window when the target volume value is greater than the first predetermined threshold. For example, when the target volume value is adjusted to 90, which is greater than the predetermined threshold of 70, the volume value of the target window may be reduced to 70. In some embodiments, when the computing device detects that the current system time is 10 o'clock at night, the window volume is reduced from 90 to 70. In some embodiments, when the computing device detects that the current device is in low performance mode, the window volume is reduced from 90 to 70.

In some embodiments, the target policy is to increase the window volume value of the target window when the target volume value is smaller than the second predetermined threshold. For example, when the target volume value is adjusted to 10, which is smaller than the predetermined threshold of 50, the volume value of the target window is increased to 60.

In some embodiments, when the computing device detects that the current system time is 9 o'clock in the morning, the window volume is increased from 10 to 90. In some embodiments, when the computing device detects that the current device is in high performance mode, the window volume is increased from 10 to 90. In some embodiments, the target policy in the set of policies is to limit the range of the target volume value and adaptively adjust the window volume value.

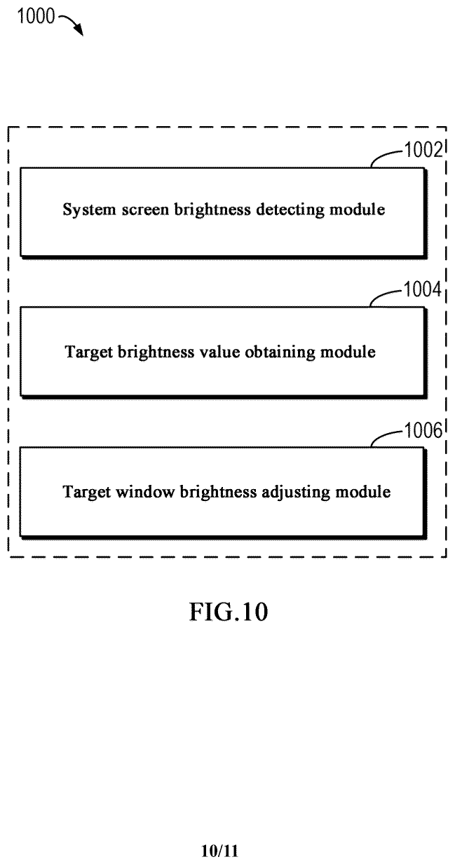

The schematic diagram of an example for adjusting window volume according to some embodiments of the present disclosure has been described above with reference to FIG. 8. Next, a schematic block diagram of an apparatus 1000 for adjusting window brightness according to some embodiments of the present disclosure is to be depicted below with reference to FIG. 10.

As shown in FIG. 10, the apparatus 1000 comprises a system screen brightness detecting module 1002 configured to detect whether a change has occurred to system screen brightness of a device; a target brightness value obtaining module 1004 configured to, in response to detecting that the system screen brightness has been changed, obtain a target brightness value for the system screen brightness; and a target window brightness adjusting module 1006 configured to adjust, based on the target brightness value, a window brightness of a target window of a target application running in the device.

In some embodiments, the system screen brightness detecting module 1002 includes: a resource identifier obtaining module configured to obtain a resource identifier corresponding to state change of the device; and a module for determining change of system screen brightness configured to determine, based on the resource identifier, whether the system screen brightness has been changed.

In some embodiments, the module for determining change of system screen brightness includes: a reference resource identifier obtaining module configured to obtain a reference resource identifier corresponding to the system screen brightness; a resource identifier matching module configured to match the resource identifier with the reference resource identifier; and the module for determining change of system screen brightness configured to, in response to the resource identifier and the reference resource identifier matching, determine that the system screen brightness has been changed.

In some embodiments, the module for determining change of system screen brightness also includes a module for determining that the system screen brightness is not changed, which module is configured to, in response to the resource identifier and the reference resource identifier not matching, determine that the system screen brightness is not changed.

In some embodiments, the target brightness value obtaining module 1004 includes: a device system information accessing module configured to, in response to detecting that the system screen brightness has been changed, obtain a target brightness value for the system screen brightness through accessing system information of the device.

In some embodiments, the target window brightness adjusting module 1006 includes: a target brightness adjustment module configured to adjust the target brightness value to a predetermined range; and a window brightness adjustment module configured to adjust, based on the adjusted target brightness value, the window brightness of the target window.

In some embodiments, the target window brightness adjusting module 1006 includes: a target policy determining module configured to determine a target policy for adjusting the window brightness; and a window brightness adjustment module configured to adjust, based on the target brightness value and the target policy, the window brightness of the target window.

In some embodiments, the target policy determining module includes: a module for displaying a set of policies configured to display a set of policies for adjusting the window brightness; a module for receiving choice of policy configured to receive a choice of a policy in the set of policies; and the target policy determining module configured to determine the policy selected as the target policy.

In some embodiments, the target policy indicates increasing brightness of a window when a brightness value of system screen brightness is lower than a first predetermined threshold; and the window brightness adjustment module configured to determine whether the target brightness value is lower than the first predetermined threshold; and a module for increasing window brightness configured to, in response to the target brightness value being lower than the first predetermined threshold, increase the window brightness of the target window.

In some embodiments, the target policy also indicates reducing brightness of a window when a brightness value of system screen brightness is greater than a second predetermined threshold, and the first predetermined threshold is smaller than the second predetermined threshold; and the window brightness adjustment module also includes: a brightness value determination module configured to determine whether the target brightness value is greater than the second predetermined threshold; and a module for decreasing window brightness configured to, in response to the target brightness value being greater than the second predetermined threshold, reduce the window brightness of the target window.

In some embodiments, the target window is a first target window and the apparatus 1100 also comprises at least one of: a window brightness maintaining module configured to, in response to switching the first target window to a second target window of the target application, maintain window brightness of the second target window at a window brightness of the first target window; or a brightness re-adjustment module configured to, in response to switching the first target window to a second target window of the target application, re-adjust a window brightness of the second target window.

In some embodiments, the apparatus 1100 also comprises: a system volume detecting module configured to detect whether a change has occurred to a system volume corresponding to the device; a target volume value obtaining module configured to, in response to detecting that the system volume has been changed, obtain a target volume value for the system volume; and a target window volume adjustment module configured to adjust, based on the target volume value, volume of the target window of the target application running in the device.

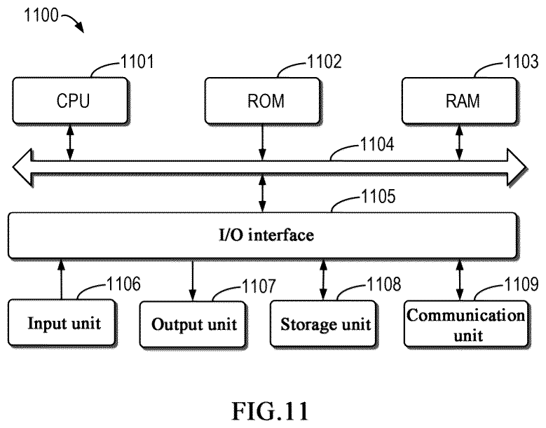

FIG. 11 illustrates a schematic block diagram of an example device 1100 for implementing embodiments of the present disclosure. The computing device 102 in FIG. 1 may be implemented by the device 1100. As shown in FIG. 11, the device 1100 comprises a central process unit (CPU) 1101, which can execute various suitable actions and processing based on the computer program instructions stored in the read-only memory (ROM) 1102 or computer program instructions loaded in the random-access memory (RAM) 1103 from the storage unit 1108. The RAM 1103 can also store all kinds of programs and data required by the operation of the device 1100. CPU 1101, ROM 1102 and RAM 1103 are connected to each other via a bus 1104. The input/output (I/O) interface 1105 is also connected to the bus 1104.

A plurality of components in the device 1100 is connected to the I/O interface 1105, including: an input unit 1106, such as keyboard, mouse and the like; an output unit 1107, e.g., various kinds of display and loudspeakers etc.; a storage unit 1108, such as disk and optical disk etc.; and a communication unit 1109, such as network card, modem, wireless transceiver and the like. The communication unit 1109 allows the device 1100 to exchange information/data with other devices via the computer network, such as Internet, and/or various telecommunication networks.

The above described procedure and processing, such as method 200 and examples 300, 400, 500, 600, 700, 800 and 900, can be executed by the processing unit 1101. For example, in some embodiments, method 200 and examples 300, 400, 500, 600, 700, 800 and 900 can be implemented as a computer software program tangibly included in the machine-readable medium, e.g., storage unit 1108. In some embodiments, the computer program can be partially or fully loaded and/or mounted to the apparatus 1100 via ROM 1102 and/or communication unit 1109. When the computer program is loaded to RAM 1103 and executed by the CPU 1101, one or more actions of the above described method 200 and examples 300, 400, 500, 600, 700, 800 and 900 can be implemented.

The present disclosure can be method, apparatus, system and/or computer program product. The computer program product can include a computer-readable storage medium, on which the computer-readable program instructions for executing various aspects of the present disclosure are loaded.

The computer-readable storage medium can be a tangible apparatus that maintains and stores instructions utilized by the instruction executing apparatuses. The computer-readable storage medium can be, but not limited to, such as electrical storage device, magnetic storage device, optical storage device, electromagnetic storage device, semiconductor storage device or any appropriate combinations of the above. More concrete examples of the computer-readable storage medium (non-exhaustive list) include: portable computer disk, hard disk, random-access memory (RAM), read-only memory (ROM), erasable programmable read-only memory (EPROM or flash), static random-access memory (SRAM), portable compact disk read-only memory (CD-ROM), digital versatile disk (DVD), memory stick, floppy disk, mechanical coding devices, punched card stored with instructions thereon, or a projection in a slot, and any appropriate combinations of the above. The computer-readable storage medium utilized here is not interpreted as transient signals per se, such as radio waves or freely propagated electromagnetic waves, electromagnetic waves propagated via waveguide or other transmission media (such as optical pulses via fiber-optic cables), or electric signals propagated via electric wires.

The described computer-readable program instruction can be downloaded from the computer-readable storage medium to each computing/processing device, or to an external computer or external storage via Internet, local area network, wide area network and/or wireless network. The network can comprise copper-transmitted cable, optical fiber transmission, wireless transmission, router, firewall, switch, network gate computer and/or edge server. The network adapter card or network interface in each computing/processing device receives computer-readable program instructions from the network and forwards the computer-readable program instructions for storage in the computer-readable storage medium of each computing/processing device.

The computer program instructions for executing operations of the present disclosure can be assembly instructions, instructions of instruction set architecture (ISA), machine instructions, machine-related instructions, microcodes, firmware instructions, state setting data, or source codes or target codes written in any combinations of one or more programming languages, wherein the programming languages comprise object-oriented programming languages, e.g., Smalltalk, C++ and so on, and traditional procedural programming languages, such as “C” language or similar programming languages. The computer-readable program instructions can be implemented fully on the user computer, partially on the user computer, as an independent software package, partially on the user computer and partially on the remote computer, or completely on the remote computer or server. In the case where remote computer is involved, the remote computer can be connected to the user computer via any type of networks, including local area network (LAN) and wide area network (WAN), or to the external computer (e.g., connected via Internet using the Internet service provider). In some embodiments, state information of the computer-readable program instructions is used to customize an electronic circuit, e.g., programmable logic circuit, field programmable gate array (FPGA) or programmable logic array (PLA). The electronic circuit can execute computer-readable program instructions to implement various aspects of the present disclosure.

Various aspects of the present disclosure are described here with reference to flow chart and/or block diagram of method, apparatus (system) and computer program products according to embodiments of the present disclosure. It should be understood that each block of the flow chart and/or block diagram and the combination of various blocks in the flow chart and/or block diagram can be implemented by computer-readable program instructions.

The computer-readable program instructions can be provided to the processing unit of general-purpose computer, dedicated computer or other programmable data processing apparatuses to manufacture a machine, such that the instructions that, when executed by the processing unit of the computer or other programmable data processing apparatuses, generate an apparatus for implementing functions/actions stipulated in one or more blocks in the flow chart and/or block diagram. The computer-readable program instructions can also be stored in the computer-readable storage medium and cause the computer, programmable data processing apparatus and/or other devices to work in a particular manner, such that the computer-readable medium stored with instructions comprises an article of manufacture, including instructions for implementing various aspects of the functions/actions stipulated in one or more blocks of the flow chart and/or block diagram.

The computer-readable program instructions can also be loaded into computer, other programmable data processing apparatuses or other devices, so as to execute a series of operation steps on the computer, other programmable data processing apparatuses or other devices to generate a computer-implemented procedure. Therefore, the instructions executed on the computer, other programmable data processing apparatuses or other devices implement functions/actions stipulated in one or more blocks of the flow chart and/or block diagram.

The flow chart and block diagram in the drawings illustrate system architecture, functions and operations that may be implemented by system, method and computer program product according to multiple implementations of the present disclosure. In this regard, each block in the flow chart or block diagram can represent a module, a part of program segment or code, wherein the module and the part of program segment or code include one or more executable instructions for performing stipulated logic functions. In some alternative implementations, it should be noted that the functions indicated in the block can also take place in an order different from the one indicated in the drawings. For example, two successive blocks can be in fact executed in parallel or sometimes in a reverse order dependent on the involved functions. It should also be noted that each block in the block diagram and/or flow chart and combinations of the blocks in the block diagram and/or flow chart can be implemented by a hardware-based system exclusive for executing stipulated functions or actions, or by a combination of dedicated hardware and computer instructions.

Various embodiments of the present disclosure have been described above and the above description is only exemplary rather than exhaustive and is not limited to the embodiments of the present disclosure. Many modifications and alterations, without deviating from the scope and spirit of the explained various embodiments, are obvious for those skilled in the art. The selection of terms in the text aims to best explain principles and actual applications of each embodiment and technical improvements made in the market by each embodiment, or enable those ordinary skilled in the art to understand embodiments of the present disclosure.

I/We claim:

1. A method for adjusting window brightness, comprising:
detecting whether a change has occurred to system screen brightness of a device;
in response to detecting that the system screen brightness has been changed, obtaining a target brightness value for the system screen brightness; and
adjusting, based on the target brightness value, window brightness of a target window of a target application running in the device.

2. The method of claim 1, wherein detecting whether a change has occurred to system screen brightness of a device comprises:
obtaining a resource identifier corresponding to state change of the device; and
determining, based on the resource identifier, whether the system screen brightness has been changed.

3. The method of claim 2, wherein determining, based on the resource identifier, whether the system screen brightness has been changed comprises:
obtaining a reference resource identifier corresponding to the system screen brightness;
matching the resource identifier with the reference resource identifier; and
in response to the resource identifier and the reference resource identifier matching, determining that the system screen brightness has been changed.

4. The method of claim 3, wherein determining, based on the resource identifier, whether the system screen brightness has been changed comprises:
in response to the resource identifier and the reference resource identifier not matching, determining that the system screen brightness is not changed.

5. The method of claim 1, wherein obtaining target brightness value for the system screen brightness in response to detecting that the system screen brightness has been changed comprises:
in response to detecting that the system screen brightness has been changed, obtaining the target brightness value for the system screen brightness by accessing system information of the device.

6. The method of claim 1, wherein adjusting, based on the target brightness value, a window brightness of a target window of a target application running in the device comprises:
adjusting the target brightness value to a predetermined range; and
adjusting, based on the adjusted target brightness value, the window brightness of the target window.

7. The method of claim 1, wherein adjusting, based on the target brightness value, a window brightness of a target window of a target application running in the device comprises:
determining a target policy for adjusting the window brightness; and
adjusting, based on the target brightness value and the target policy, the window brightness of the target window.

8. The method of claim 7, wherein determining a target policy for adjusting the window brightness comprises:
displaying a set of policies for adjusting the window brightness;
receiving a choice of a selected policy in the set of policies; and
determining the selected policy as the target policy.

9. The method of claim 7, wherein the target policy indicates increasing brightness of a window in response to a brightness value of system screen brightness being lower than a first predetermined threshold, and adjusting, based on the target brightness value and the target policy, the window brightness of the target window comprises:
determining whether the target brightness value is lower than the first predetermined threshold; and
in response to the target brightness value being lower than the first predetermined threshold, increasing the window brightness of the target window.

10. The method of claim 9, wherein the target policy further indicates reducing brightness of a window in response to a brightness value of system screen brightness being greater than a second predetermined threshold, wherein the first predetermined threshold is smaller than the second predetermined threshold; and adjusting, based on the target brightness value and the target policy, the window brightness of the target window further comprises:
determining whether the target brightness value is greater than the second predetermined threshold; and
in response to the target brightness value being greater than the second predetermined threshold, reducing the window brightness of the target window.

11. The method of claim 1, wherein the target window is a first target window and the method further comprises one of:
in response to the first target window being switched to a second target window of the target application, maintaining window brightness of the second target window as a window brightness of the first target window;
in response to the first target window being switched to a second target window of the target application, re-adjusting window brightness of the second target window.

12. The method of claim 1, further comprising:
detecting whether a change has occurred to a system volume corresponding to the device;
in response to detecting that the system volume has been changed, obtaining a target volume value for the system volume; and
adjusting, based on the target volume value, volume of the target window of the target application running in the device.

13. An electronic device, comprising:
at least one processor; and
a memory for storing instructions which, when executed by the at least one processor, causes the at least one processor to:
detect whether a change has occurred to system screen brightness of a device;
in response to detecting that the system screen brightness has been changed, obtain a target brightness value for the system screen brightness; and
adjust, based on the target brightness value, window brightness of a target window of a target application running in the device.

14. The device of claim 13, wherein the instructions causing the processor to detect whether a change has occurred to system screen brightness of a device comprise instructions causing the processor to:
obtain a resource identifier corresponding to state change of the device; and
determine, based on the resource identifier, whether the system screen brightness has been changed.

15. The device of claim 14, wherein instructions causing the processor to determine, based on the resource identifier, whether the system screen brightness has been changed comprise instructions causing the processor to:
obtain a reference resource identifier corresponding to the system screen brightness;
match the resource identifier with the reference resource identifier; and
in response to the resource identifier and the reference resource identifier matching, determine that the system screen brightness has been changed.

16. The device of claim 15, wherein instructions causing the processor to determine, based on the resource identifier, whether the system screen brightness has been changed comprises instructions causing the processor to:
in response to the resource identifier and the reference resource identifier not matching, determine that the system screen brightness is not changed.

17. The device of claim 13, wherein the instructions causing the processor to obtain target brightness value for the system screen brightness in response to detecting that the system screen brightness has been changed comprises instructions causing the processor to:
in response to detecting that the system screen brightness has been changed, obtain the target brightness value for the system screen brightness by accessing system information of the device.

18. The device of claim 13, wherein the instructions causing the processor to adjust, based on the target brightness value, a window brightness of a target window of a target application running in the device comprises instructions causing the processor to:
adjust the target brightness value to a predetermined range; and
adjust, based on the adjusted target brightness value, the window brightness of the target window.

19. The device of claim 13, wherein instructions causing the processor to adjust, based on the target brightness value, a window brightness of a target window of a target application running in the device comprises instructions causing the processor to:
determine a target policy for adjusting the window brightness; and
adjust, based on the target brightness value and the target policy, the window brightness of the target window.

20. A non-transitory computer-readable storage medium with computer programs stored thereon which, when executed by a processor, cause the processor to:
detect whether a change has occurred to system screen brightness of a device;
in response to detecting that the system screen brightness has been changed, obtain a target brightness value for the system screen brightness; and
adjust, based on the target brightness value, window brightness of a target window of a target application running in the device.
